(19) United States
(12) Patent Application Publication
(10) Pub. No.: US 2025/0094050 A1
(43) Pub. Date: Mar. 20, 2025

(54) METHOD, DEVICE, AND PROGRAM PRODUCT FOR STORAGE

(71) Applicant: Dell Products L.P., Round Rock, TX (US)

(72) Inventors: Xingshan Wang, Shanghai (CN); Ao Sun, Shanghai (CN); Yu Teng, Shanghai (CN)

(21) Appl. No.: 18/525,691

(22) Filed: Nov. 30, 2023

(30) Foreign Application Priority Data
Sep. 15, 2023 (CN) 202311198192.7

(51) Int. Cl. G06F 3/06; G06F 13/16

(52) U.S. Cl. CPC G06F 3/061; G06F 3/0644; G06F 3/0647; G06F 3/067; G06F 13/1668

(57) ABSTRACT

The subject technology relates to storage. For instance, data is received through a first container in a first pod. The data is transmitted from the first container to a second container in the first pod through a transmission protocol, wherein the second container is used for assisting in implementing functions of the first pod and includes huge pages, and the data can be written to a disk through the second container. Beneficially, memory sharing between different pods or a plurality of containers can be achieved, thereby significantly improving the storage performance of large objects in an object storage system, and enabling some containers to have their dedicated resources.

### RELATED APPLICATION

The present application claims the benefit of priority to Chinese Patent Application No. 202311198192.7, filed on Sep. 15, 2023, which application is hereby incorporated into the present application by reference herein in its entirety.

### TECHNICAL FIELD

Embodiments of the present disclosure relate to the field of computers, and more particularly, to a method, a device, and a program product for storage.

### BACKGROUND

Cloud native object storage systems can provide high-performance storage for customers or consumers. For example, a cloud native object storage system that runs based on Kubernetes can be centrally managed across edge positions, automatically perform operations, and provide flexibility through its open design, thereby ensuring zero trust security and providing multi-cloud connection. A Nonvolatile Memory Express (NVMe) version of a cloud native object storage system may be based on NVMe-over-Fabrics (NVMe-oF), thereby allowing access to storage of, for example, a solid-state drive.

At the same time, a cloud native object storage system may also be extended to any capacity, and the site can be connected only with one click, which can be used as a globally accessible data lake for enterprise workloads such as cloud native, artificial intelligence (AI), analysis, and archiving.

### SUMMARY

The following presents a simplified summary of the disclosed subject matter in order to provide a basic understanding of some example embodiments of the disclosed subject matter. This summary is not an extensive overview of the disclosed subject matter. It is intended to neither identify key or critical elements of the disclosed subject matter nor delineate the scope of the disclosed subject matter. Its sole purpose is to present some concepts of the disclosed subject matter in a simplified form as a prelude to the more detailed description that is presented later.

Embodiments of the present disclosure relate to a method, a device, and a computer program product for storage.

According to a first example embodiment of the present disclosure, a method for storage is provided. The method includes receiving data through a first container in a first pod. The method further includes transmitting the data from the first container to a second container in the first pod through a transmission protocol, wherein the second container is used for assisting in implementing functions of the first pod and includes huge pages, and writing the data to a disk through the second container.

According to a second example embodiment of the present disclosure, a device, e.g., an electronic device, for storage is provided. The device includes at least one processor; and a memory coupled to the at least one processor and storing instructions, wherein the instructions, when executed by the at least one processor, cause the device to perform actions including: receiving data through a first container in a first pod. The device further includes transmitting the data from the first container to a second container in the first pod through a transmission protocol, wherein the second container is used for assisting in implementing functions of the first pod and includes huge pages, and writing the data to a disk through the second container.

According to a third example embodiment of the present disclosure, a computer program product is provided. The computer program product is tangibly stored on a non-volatile computer-readable medium and includes machine-executable instructions, wherein the machine-executable instructions, when executed, cause a machine to perform acts of the method in the first example embodiment of the present disclosure.

### BRIEF DESCRIPTION OF THE DRAWINGS

By description of example embodiments of the present disclosure in more detail with reference to the accompanying drawings, the above and other objectives, features, and advantages of the present disclosure will become more apparent. In the example embodiments of the present disclosure, the same reference numerals generally represent the same elements.

FIG. 1 is a schematic diagram of an example storage system in which a device and/or a method according to embodiments of the present disclosure can be implemented;

FIG. 2 is a flow chart of a method for storage according to some embodiments of the present disclosure;

FIG. 3 is an internal structural diagram of an engine pod as a second pod according to some embodiments of the present disclosure;

FIG. 4 is a schematic diagram of an IO path for interaction between an engine pod and a data head service pod implemented according to some embodiments of the present disclosure;

FIG. 5 is a schematic diagram of performing memory sharing between a sidecar container and another container according to some embodiments of the present disclosure;

FIG. 6 is a diagram showing some experimental results according to some embodiments of the present disclosure; and

FIG. 7 is a schematic block diagram of an example device which may be used for implementing the embodiments of the present disclosure.

### DETAILED DESCRIPTION

Example embodiments of the present disclosure will be described in more detail below with reference to the accompanying drawings. Some specific embodiments of the present disclosure are shown in the accompanying drawings; however, it should be understood that the present disclosure may be implemented in various forms, and should not be limited to the embodiments set forth herein. Rather, these embodiments are provided to make the present disclosure more thorough and complete and to fully convey the scope of the present disclosure to those skilled in the art.

The term “include” and variants thereof used herein indicate open-ended inclusion, that is, “including but not limited to.” Unless specifically stated, the term “or” means “and/or.” The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects, unless otherwise specifically indicated.

Cloud native object storage systems can provide high-performance storage and meet requirements of modern workloads such as AI, big data, and machine learning, and therefore, their performance becomes crucial. By utilizing the memory sharing technology, memory replication can be avoided as much as possible. However, in storage systems based on such as Kubernetes, memory sharing across pods is not allowed due to security and isolation reasons.

With the rapid development of hardware across computing, storage, and networking, the software overhead has become significant. In high-throughput situations, the bottleneck that leads to increased software overhead is excessive memory replication operations in an IO path, which plays a crucial role in performance optimization. In addition, in performance testing, the total throughput of a storage system is usually not limited by hardware, but by software costs.

By minimizing the amount of data replication between pods, shared memory can be incorporated on an (input output) IO path between two components. However, different components are deployed in different Kubernetes pods and different namespaces, which complicates the implementation of shared memory across containers and also violates the Kubernetes resource isolation principle. Ensuring cross pod security during memory sharing is difficult, and careful consideration is required to avoid potential security risks. In addition, implementations such as NVMe-oF engines are typically based on a Storage Performance Development Kit (SPDK), which uses huge memory pages and does not support regular memory sharing. At the same time, sidecar containers also need to consume resources, which thus brings resource challenges.

In order to at least address the above and other potential problems, an embodiment of the present disclosure provides a method for storage. The method includes receiving data through a first container in a first pod. The method further includes transmitting the data from the first container to a second container in the first pod through a transmission protocol, wherein the second container is used for assisting in implementing functions of the first pod and includes huge pages, and writing the data to a disk through the second container. By using the method, memory sharing can be achieved between different pods or a plurality of containers. It can significantly improve the storage performance of large objects in a cloud-based native object storage system and can be used as a useful reference for similar scenarios running on Kubernetes. According to the implementation of the present disclosure, resource consumption can also be reduced by creating a sidecar container with the same function as an original pod and placing it in a pod that intends to have shared memory access. According to the implementation of the present disclosure, some consumer containers/services have their own dedicated resources by owning a sidecar container when the sidecar container is located on a critical IO path. Other consumer containers/services can continue to share resources in the original pod as usual.

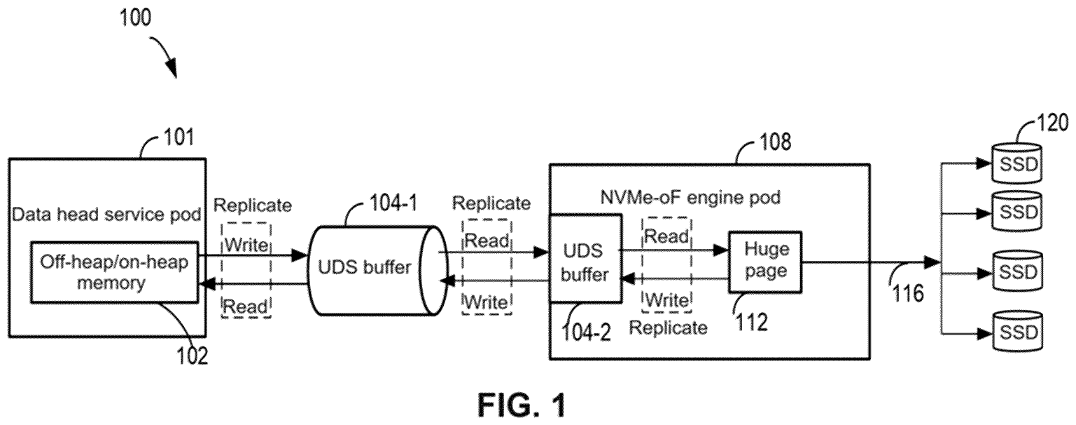

The fundamental principles and a plurality of example embodiments of the present disclosure will be described in detail below with reference to the accompanying drawings. FIG. 1 is a schematic diagram of an example storage system 100 in which a device and/or a method according to embodiments of the present disclosure can be implemented. The example storage system 100 in FIG. 1 may include a data head service pod (“dataheadSvc pod”) 101 and its on-heap/off-heap memory 102, UDS (“Unix Domain Socket”) buffers 104-1 and 104-2, an NVMe-oF engine pod 108, a huge page 112, an NVMe-oF protocol 116, and one or a plurality of disks 120 such as SSDs. It should be understood that the types and the numbers, the data transmission process, the arrangement, and the like of the components shown in FIG. 1 are only examples, and the example storage system 100 may include different numbers and arrangements of components, data transmission processes, various additional elements, and the like. For example, the storage system may further have one or a plurality of other pods. It should also be understood that the above examples are only used for illustrating the storage method.

The data head service pod 101 may be a pod based on, for example, an S3 (“Simple Storage Service”) head service protocol, which may accept various input data from users, for example, object storage data such as photos, videos, documents, logs, and backups uploaded by the users through a data head interface, thereby storing the user data in the storage system 100. In the process of reading and writing the user data, the data head service pod 101 may consume a large amount of resources in the storage system 100, such as CPU resources and memory resources.

It should also be understood that in the embodiments of the present disclosure, as an example, pods such as the data head service pod 101 and the NVMe-oF engine pod 108 may each include one or a plurality of containers, and these containers share the same network namespace, storage volume, and other resources. The pod is typically used for running different parts of an application, and these parts need to work cooperatively and share the same context. Containers within a pod may directly communicate with each other because they run in the same network namespace. The pods such as the data head service pod 101 and the NVMe-oF engine pod 108 may be isolated from each other, and different pods have different namespaces.

The data head service pod 101 itself does not have the ability, and therefore, it may first store the data from users in its own on-heap/off-heap memory 102 based on mechanisms such as a JAVA virtual machine. The data head service pod 101 may then transmit the stored data to the NVMe-oF engine pod 108 through a UDS buffer 104. The NVMe-oF engine pod 108 may provide underlying IO storage services for other pods, ultimately write the user data to the disk 120, and be responsible for accessing drives/disks 120 on remote hosts through an NVMe-oF engine structure.

The UDS buffers 104-1 and 104-2 may be protocols used for performing communication and data transmission between processes/pods on the same computer. The data head service pod 101 may first write the data from a user to the UDS buffer 140-2 sending the socket. The NVMe-oF engine pod 108 may then store the data in its own UDS buffer 140-2. The data in the UDS buffer 140-2 cannot directly access the disk 120 through the NVMe-oF protocol 116, and therefore, the NMe-OF engine pod 108 may first write/read the data to/from the huge page 112. As an example, in the embodiment of the present disclosure, the huge page 112 may be a memory page with a size larger than that of a general memory page. For example, the huge page 112 may have a memory page of 2 MB in size, while the general memory page size is typically around several KB.

Therefore, FIG. 1 illustrates a data persistent IO path from the data head service pod 101 to the NVMe-oF engine pod 108. The data head service pod 101 may send IO data to the NVMe-oF engine pod 108 or receive IO data from the NVMe-oF engine pod 108 via the UDS buffers 104-1 and 104-2. Three data replication operations are required for each piece of IO data. This increases the number of reads and writes during the replication process and the resource consumption of the storage system 100.

The storage system 100 may be installed in any computing device having processing resources or storage resources. For example, the computing device may have common capabilities such as receiving and sending data requests, real-time data analysis, local data storage, and real-time network connection. The computing device may typically include various types of devices. Examples of the computing device may include, but are not limited to, a desktop computer, a laptop computer, a smartphone, a wearable device, a security device, a smart manufacturing device, a smart home device, an Internet of Things (IoT) device, a smart car, a drone, and the like, which is not limited in any way by the present disclosure.

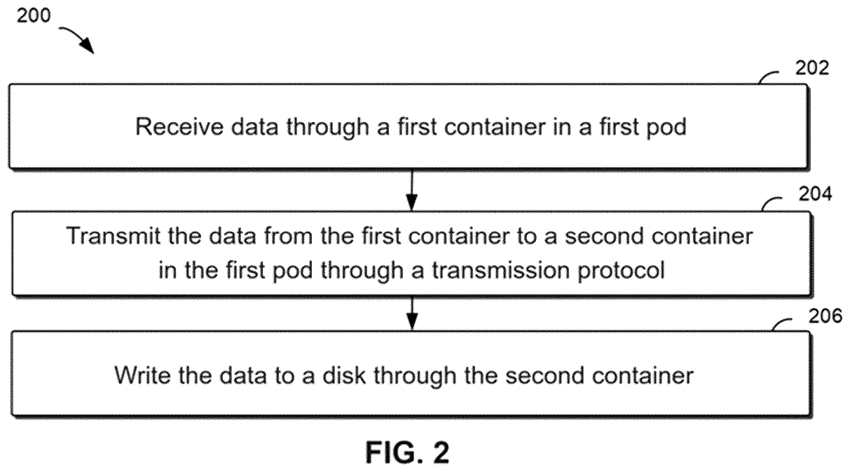

The schematic diagram in which the method and/or process according to embodiments of the present disclosure may be implemented is described above with reference to FIG. 1. A flow chart of a method 200 for storage according to an embodiment of the present disclosure will be described below with reference to FIG. 2. The method 200 for storage according to embodiments of the present disclosure may be performed at an edge device with computing power or at a cloud server, and the present disclosure is not limited in this regard. In order to more effectively provide read and write efficiency for storage, a method for storage according to the embodiment of the present disclosure is proposed.

At a block 202, data is received through a first container in a first pod. According to the embodiment of the present disclosure, as an example, the first pod may be a data head service pod, which can accept various types of data uploaded by users, for example, object data such as photos and videos, and temporarily store the data in one container in the data head service pod.

At a block 204, the data is transmitted from the first container to a second container in the first pod via a transmission protocol, wherein the second container is used for assisting in implementing functions of the first pod and includes huge pages. According to the embodiment of the present disclosure, as an example, the second container may be a sidecar container. The sidecar container typically runs together with a main application pod, such as a data head service pod, but does not provide a core function of the application. Instead, it provides some additional functions or services to the application without modifying code of the main application. As an example, the sidecar container may be used for collecting logs generated by a main container and sending them to a log collection system for monitoring and analysis. In some embodiments, the sidecar container may further be used for running a monitoring agent or metric collector to monitor performance indicators of the main container in real-time and report to a monitoring system. In some embodiments, the sidecar container may be used for dynamically managing the configuration of an application and updating configuration parameters as needed. In summary, the sidecar container can assist in enhancing the function and performance of an application while maintaining the simplicity and maintainability of a container of the application.

As an example, the sidecar container may be initially deployed in a second pod such as an NVMe-oF engine pod. The second pod may be connected and communicate with the first pod through the transmission protocol of the UDS buffer and transmit data. The second pod may further provide underlying service support for services required by the first pod, such as responsibility for managing and running the first container, scheduling resources in the container, maintaining load balancing, and writing the data collected in the first pod to a disk of a storage system.

When the load in the first pod increases, the second pod first deploys one or a plurality of huge pages in its internal huge pages to the second container, and then deploys the second container to the first pod. In order to enable the one or a plurality of huge pages to be dedicated to processing read and write requests among data, the processing system may generate IO threads by binding the one or a plurality of huge pages to a core in its central processing unit, and then deploy the IO threads to the second container such as a sidecar container. These IO threads, also known as IO worker threads, are responsible for handling operations such as reading a file, sending a network request, and database query. They may be responsible for initiating and managing IO operations, and then returning results to a main thread or another thread that requires the data. This method can improve the responsiveness of the application, as the container/application will not be blocked by the IO operations and may continue to perform other tasks.

At a block 206, the data is written to a disk via the second container. The huge pages have been deployed to the second container in the first pod, and therefore, the second container may generate a huge page file table based on the huge pages deployed in the second container. The huge page file table may include huge page files and sizes. The first container may then write the data to one or a plurality of huge pages of the second container by modifying the huge page file table, and write the data to a disk such as an SSD through the one or a plurality of huge pages. Additionally or alternatively, in some embodiments, when the load or read/write operations in the first pod decrease, the second container deployed in the first pod may be removed and redeployed to the second pod to wait for re-allocation of the second pod, thus allowing the second container to be flexibly applied and deployed.

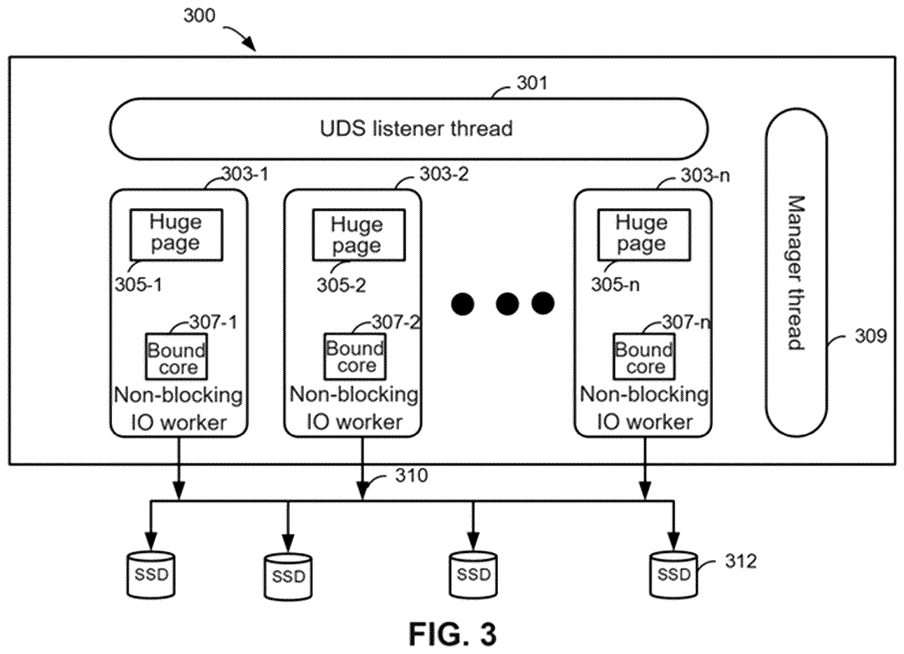

The flow chart of the method 200 for storage according to an embodiment of the present disclosure is described above with reference to FIG. 2. An internal structural diagram of an NVMe-oF engine pod 300 serving as the second pod according to an embodiment of the present disclosure will be described below with reference to FIG. 3. The NVMe-oF engine pod 300 may provide underlying services such as storage and running for one or a plurality of containers in a memory system including the first pod.

As shown in FIG. 3, the NVMe-oF engine pod 300 may include, but is not limited to, a UDS listener thread 301, IO worker threads 303-1 to 303-n, huge pages 305-1 to 305-n, bound cores 307-1 to 307-n, a manager thread 309, a hard disk 312, and other elements. The NVMe-oF engine pod 300 may further perform communication and data transmission with one or a plurality of hard drives, such as SSDs, mounted in the storage system through the NVMe-oF protocol, so that data from users can be transmitted to the storage system. It should be understood that the NVMe-oF engine pod 300 may further include different numbers and arrangements of components and/or various additional elements, and the like. It should also be understood that the above example is only used to illustrate the NVMe-oF engine pod 300.

The IO worker threads 303-1 to 303-n may also be referred to as task threads, and these threads are unique work units and may consume a large amount of resources in the process. A plurality of task threads may share services or resources with each other. These task threads may simultaneously access, modify, or use certain shared resources, such as shared memory regions, database connection pools, and network sockets. The number of task threads may be increased or decreased based on the service capabilities required by the consumer service/data head service pod.

Referring to FIG. 3, the IO worker threads 303-1 to 303-n may further include one or a plurality of huge pages 305-1 to 305-n, and these huge pages may be used for handling workloads such as large databases, high-performance computing, and virtualization to improve memory access efficiency and reduce memory management overhead. A common memory page is usually 4 KB or smaller in size. In contrast, the huge pages 305-1 to 305-n are larger memory pages, typically 2 MB or larger in size. The larger page size may have several performance advantages, including but not limited to reducing the number of memory page tables, thereby reducing the overhead of page table lookup, as more page table entries are needed to manage the same amount of memory when using small pages. The huge pages may also improve a Translation Lookaside Buffer (TLB) hit rate, thereby reducing the memory access time. The number of pages that need to be managed by using the huge pages 305-1 to 305-n is less, and therefore, the memory management overhead may be reduced.

The IO worker threads 303-1 to 303-n may further include one or a plurality of bound cores 307-1 to 307-n from a plurality of cores of the central processing unit CPU. These cores may be dedicated to processing data of the IO worker threads 303-1 to 303-n without participating in the processing of other computing resources, so that the IO worker threads 303-1 to 303-n can more efficiently utilize processing computing resources, thereby reducing the thread switching overhead, reducing the risk of competition conditions, maximizing the use of CPU computing resources, and ensuring that tasks are executed in a highly scalable manner across a plurality of threads.

The NVMe-oF engine pod 300 may also include the UDS listener thread 301, which may be used for listening for UDS connection requests from, for example, the data head service pod and/or other pods and containers, and accepting these connections. After the UDS listener thread 301 receives these connections, it may allocate one or a plurality of threads of the IO worker threads 303-1 to 303-n through the manager thread 309 to these connections for processing incoming data.

According to the embodiment of the present disclosure, as an example, the manager thread 309 may allocate the IO worker threads 303-1 to 303-n based on the number of UDS interfaces in the UDS listener thread 301. For example, the UDS listener thread 301 may have 10 UDS interfaces, and each UDS interface may be bound to 100 IO worker threads in the plurality of IO worker threads 303-1 to 303-n through the manager thread 309, thus achieving mutual binding between one UDS interface and a plurality of IO worker threads. The IO worker threads may also be designed as non-blocking threads that can continue to perform other tasks or poll operations without waiting for an operation to complete or a condition to be met.

When receiving data from another pod, the UDS listener thread 301 may poll (periodically check) whether an (a plurality of) IO worker thread(s) bound to each UDS interface is/are being used to determine the availability thereof. If the (plurality of) IO worker thread(s) is/are currently performing read and write operations, the UDS listener thread 301 may choose not to call the (plurality of) IO worker thread(s).

When it is determined that the IO worker threads bound to each UDS interface are available, the UDS listener thread 301 may allocate read and write tasks to these IO worker threads. The IO worker threads may then write data to their internal huge pages and write the data to one or a plurality of hard drives 312, such as SSDs, mounted in the storage system through the NVMe-oF protocol. The IO worker threads 303-1 to 303-n may be deployed to a sidecar pod such as the second container.

In this way, the NVMe-oF engine pod 300 is divided into two instances, namely with reduced task threads and sidecar containers. The sidecar container may then be allocated to a pod for key consumers of head services in the IO path, such as the data head service pod. Placing the sidecar container in the pod of consumer services makes it more flexible, and it is easier to implement memory sharing or other operations that do not support across pods. The method may also be a universal solution for solving similar problems/scenarios.

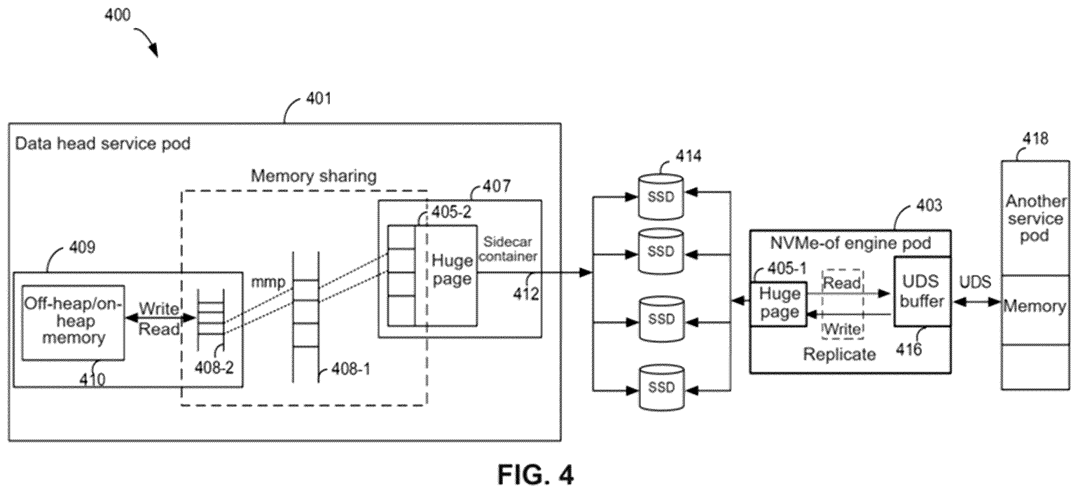

FIG. 4 illustrates a schematic diagram of an IO path 400 for interaction between an engine pod and a data head service pod implemented according to an embodiment of the present disclosure. As shown in FIG. 4, when the load in a data head service pod 401 increases, an NVMe-oF engine pod 403 may redeploy one or a plurality of memory pages, such as a huge page 405-2, in a deployed huge page 405-1 to a second container such as a sidecar container 407 through IO worker threads. Subsequently, the sidecar container 407 may be deployed to the data head service pod 401. The sidecar container 407 may allocate the memory and create a memory file mapping (mmp) based on the huge page 405-2 deployed therein.

The memory file mapping may map a part of a memory file or the entire memory file in the (plurality of) huge page(s) 405-2 to a process space of the data head service pod 401, allowing data to be read and written directly in the memory without explicit data read and write operations and replicate operations. This can reduce data transmission and can be implemented by, for example, pointers or indexes.

As an example, the sidecar container 407 may allocate the huge page 405-2 deployed therein, thereby creating memory files of the huge page 405-2. The sidecar container 407 may generate a huge page file table 408-1 based on necessary information associated with the memory files of the huge page 405-2. The huge page file table 408-1 may include huge page files such as mem_file_map_0, mem_file_map_1, . . . , mem_file_map_N, and capacity sizes. The huge page file table 408-1 may then be transmitted via the UDS transmission protocol to a first container, such as a container 409, of the data head service pod 401 to form another huge page file table 408-2. The huge page file table 408-2 may be mapped to a process space of container 409 through memory file mapping. In this way, memory sharing between different containers may be achieved.

When the container 409 receives data from a user, it may first temporarily store the data in its corresponding off-heap/on-heap memory 410, and then the container 409 may modify the data in the huge page file table 408-2. The modified data in the huge page file table 408-2 may then be transmitted to the sidecar container 407 through the UDS transmission protocol. The sidecar container 407 makes corresponding modifications to the huge page file table 408-1 and the huge page 405-2 based on the modified data. The modified data may ultimately be read from or written into the huge page 405-2 of the sidecar container 407. The sidecar container 407 may then write the data from the huge page 405-2 to a target hard disk 414, such as an SSD, via a transmission protocol such as an NVMe-oF protocol.

At the same time, the NVMe-oF engine pod 403 may further receive input data from a memory in another service container 418 in the storage system through its own UDS buffer 416 via the UDS transmission protocol. The input data may also be written to the huge page 405-1 and be ultimately read from/written to the target hard drive 414 such as an SSD. In this way, services of the NVMe-oF engine pod 403 may be divided into two or more instances, and task threads may still be considered as unique resources. If the total number of task threads remains unchanged, the CPU, memory, and other resources consumed by the storage system/cluster may not be affected, which is crucial for a system with limited resources. According to the increase/decrease in load in different pods in the storage system, task threads may be deployed to different pods.

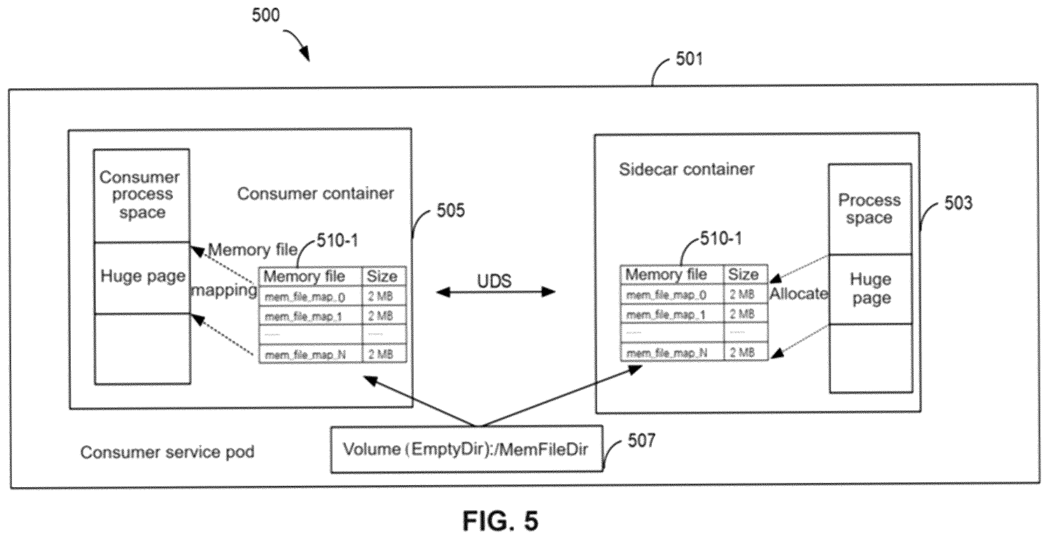

FIG. 5 illustrates a schematic diagram of performing memory sharing 500 between a sidecar container and another container according to some embodiments of the present disclosure. Even within the same pod, processes running within the containers are isolated from each other. According to an embodiment of the present disclosure, a method for memory sharing across containers in the same pod is provided. As an example, a sidecar container 503 from an NVMe-oF engine pod may be deployed to a consumer pod 501, such as a data head service pod. In the context of the present disclosure, as an example, a consumer container may be a container that acquires data from other containers or external services, performs certain operations, or consumes certain resources to support different functions and requirements of an application.

The sidecar container 503 may then allocate huge pages from the NVMe-oF engine pod in its process space so that the allocated huge pages form one or a plurality of memory files, and a huge page file table 510-1 is created based on the allocated huge pages. The huge page file table 510-1 may include necessary information associated with the memory files, such as memory file names and sizes.

The sidecar container 503 may then transmit/mount the huge page file table 510-1 to a consumer container 505 in the consumer pod 501 through the UDS transmission protocol and an emptyDir storage volume 507. The emptyDir storage volume 507 is a temporary directory created by the container, which can conveniently provide shared storage for the containers in the pod without additional configurations.

The consumer container 505 may generate another huge page file table 510-2 based on the transmitted huge page file table 510-1, and map the huge page file table 510-2 to its own consumer process space through memory file mapping, thereby achieving access to the deployed huge pages in the sidecar container 503. The consumer container 505 may then make a modification, such as read and write, to the deployed huge pages in the sidecar container 503.

The sidecar container 503 may also identify a memory update made by the consumer container 505 through memory file mapping. The method implemented through the present disclosure does not require any additional dependencies, such as a new library or a framework, so that it becomes a simple and flexible solution that can be easily implemented in other scenarios.

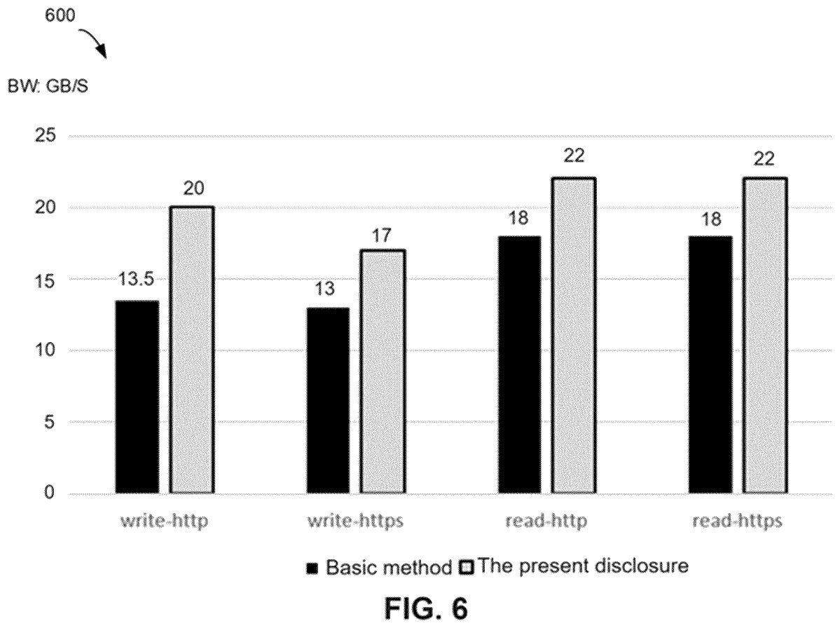

FIG. 6 illustrates a diagram of some experimental results 600 according to some embodiments of the present disclosure. FIG. 6 is used for Proof of Concept (POC) proposed in the present disclosure. According to the embodiment of the present disclosure, experiments may be conducted on a test bed with large writes (such as an object size of 256 MB). The configuration of the test bed may include: a CPU being Intel® Xeon® Gold 6430, a dynamic random access memory (DRAM) being 256 GB, a DDR5, an operating system being SUSE Linux Enterprise Server 15 (x86_64, version 15, patch level 14), a front-end network interface card (NIC) being BCM5720 Gigabit Ethernet PCIe, 50 Gb/s, a back-end network interface card being Mellanox MT2892 Family [ConnectX-6 Dx], 200 Gb/s, an SPDK version being v22.01. x, a huge page having a size of 2 MB, and a load tool being Mongoose-4.3.2.

The vertical axis of FIG. 6 represents the throughput of storage systems implemented according to different methods, which may represent the speed or capacity at which data may be processed or transmitted in a computer system or a storage system. It is usually used for measuring the performance and efficiency of a system. The throughput includes read throughput and write throughput. The read throughput refers to the speed at which a system can read data from a storage device such as a hard drive, a solid-state drive, and a memory. The write throughput refers to the speed at which a system can write data to a storage device. The level of the read and write throughputs directly affects the performance and response time of the system, and is also one of key indicators for evaluating the performance of the storage and computing systems.

The horizontal axis represents write and read operations performed based on the HTTP (Hypertext Transmission protocol) protocol and the HTTPS (HTTP Secure) protocol, respectively. As can be seen from FIG. 6, the throughput of writing through the http protocol based on the basic method is 13.5 GB/S, while the throughput of writing through the http protocol based on the method implemented in the present disclosure may reach 20 GB/S. The throughput of writing through the https protocol based on the basic method is 13 GB/S, while the throughput of writing through the https protocol based on the method implemented in the present disclosure may reach 17 GB/S.

The throughput of reading through the http protocol based on the basic method is 18 GB/S, while the throughput of reading through the http protocol based on the method implemented in the present disclosure may reach 22 GB/S. The throughput of reading through the https protocol based on the basic method is 18 GB/S, while the throughput of reading through the https protocol based on the method implemented in the present disclosure may reach 22 GB/S. These experimental results demonstrate that compared with the performance of the basic method, the optimization of the method implemented according to the present disclosure can bring great benefits to the improvement of the read and write performance.

Therefore, the present disclosure proposes a universal solution based on cross-pod process communication in Kubernetes, which can share memory or other resources. It is achieved by decomposing flexible task threads into sub-instances specifically designed for consumer containers. Memory sharing is successfully implemented on Kubernetes based on the method implemented in the present disclosure. The flexible implementation of memory sharing and the UDS connection attached to the sidecar container can ensure flexibility and load balancing. The method implemented according to the present disclosure may also provide reference for storage systems that encounter similar challenges. It should also be understood that although Kubernetes is used as an example container arrangement and management platform in the present disclosure, the method implemented according to the present disclosure may also be applied to any other known or unknown platform based on other architectures or configurations, such as Docker Swarm, Nomad, and Azure Kubernetes Service, which is not limited in the present disclosure.

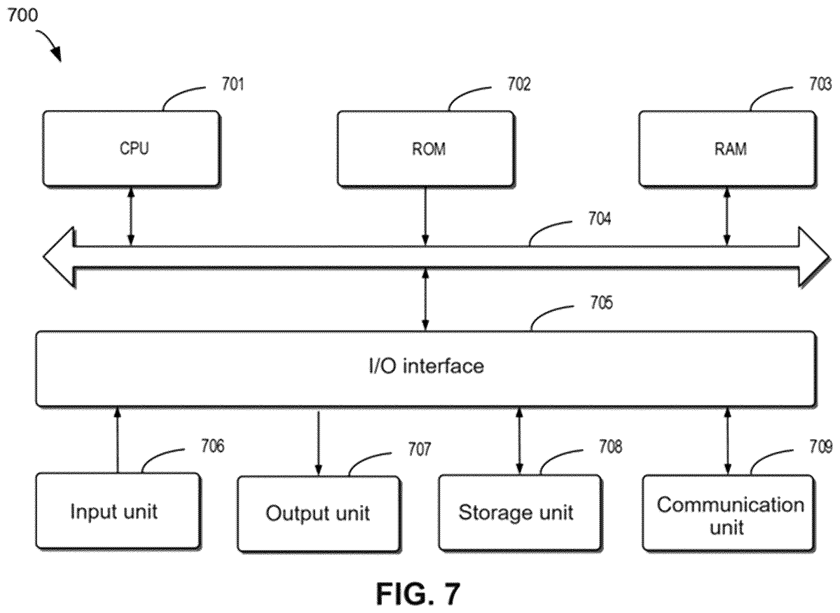

FIG. 7 illustrates a schematic block diagram of an example device 700 which can be used to implement embodiments of the present disclosure. The computing device in FIG. 1 may be implemented using the device 700. As shown in the figure, the device 700 includes a central processing unit (CPU) 701 that may execute various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The CPU 701, the ROM 702, and the RAM 703 are connected to each other through a bus 404. An Input/Output (I/O) interface 705 is also connected to the bus 704.

A plurality of components in the device 700 are connected to the I/O interface 705, including: an input unit 706, such as a keyboard and a mouse; an output unit 707, such as various types of displays and speakers; a storage page 708, such as a magnetic disk and an optical disc; and a communication unit 709, such as a network card, a modem, and a wireless communication transceiver. The communication unit 709 allows the device 700 to exchange information/data with other devices via a computer network, such as the Internet, and/or various telecommunication networks.

The various processes and processing described above, such as the method 200, may be performed by the processing unit 701. For example, in some embodiments, the method 200 may be implemented as a computer software program that is tangibly included in a machine-readable medium, such as the storage unit 708. In some embodiments, part or all of the computer program may be loaded and/or installed onto the device 700 via the ROM 702 and/or the communication unit 709. When the computer program is loaded into the RAM 703 and executed by the CPU 701, one or more actions of the method 200 described above may be performed.

The present disclosure may be a method, an apparatus, a system, and/or a computer program product. The computer program product may include a computer-readable storage medium on which computer-readable program instructions for performing various example embodiments of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, wherein the programming languages include object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various example embodiments of the present disclosure.

Various example embodiments of the present disclosure are described here with reference to flow charts and/or block diagrams of the method, the apparatus (system), and the computer program product according to the embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various example embodiments of the functions/actions specified in one or a plurality of blocks in the flow charts and/or block diagrams.

The computer-readable program instructions may also be loaded to a computer, a further programmable data processing apparatus, or a further device, so that a series of operating acts may be performed on the computer, the further programmable data processing apparatus, or the further device to produce a computer-implemented process, such that the instructions executed on the computer, the further programmable data processing apparatus, or the further device may implement the functions/actions specified in one or a plurality of blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

The embodiments of the present disclosure have been described above. The above description is illustrative, rather than exhaustive, and is not limited to the disclosed various embodiments. Numerous modifications and alterations are apparent to persons of ordinary skill in the art without departing from the scope and spirit of the illustrated embodiments. The selection of terms as used herein is intended to best explain the principles and practical applications of the various embodiments or technical improvements to technologies on the market, or to enable other persons of ordinary skill in the art to understand the embodiments disclosed here.

What is claimed is:

1. A method, comprising:
receiving, by a system comprising at least one processor, data through a first container in a first pod;
transmitting the data from the first container to a second container in the first pod through a transmission protocol, wherein the second container is used for assistance in implementing functions of the first pod and comprises huge pages; and
writing the data to a disk through the second container.

2. The method according to claim 1, wherein the second container is in a second pod, and wherein the second pod is connected to the first pod through the transmission protocol and provides services required for the first pod, and the method further comprises:
deploying, in response to a load change in the first pod, at least one of the huge pages of the second pod to the second container; and
deploying the second container to the first pod.

3. The method according to claim 2, wherein deploying the at least one of the huge pages of the second pod to the second container comprises:
generating input/output (IO) worker threads by binding the at least one of the huge pages to a core in a central processing unit; and
deploying the IO worker threads to the second container.

4. The method according to claim 3, further comprising:
allocating the IO worker threads through a number of interfaces of the transmission protocol connected to the second pod, resulting in each interface of the transmission protocol having a same number of IO worker threads.

5. The method according to claim 3, wherein the IO worker threads are non-blocking IO threads, and wherein the IO worker threads are polled to confirm availability for deployment of the IO worker threads to the second container.

6. The method according to claim 1, wherein writing the data to the disk through the second container comprises:
generating, by the second container, a huge page file table based on the at least one of the huge pages deployed in the second container, wherein the huge page file table comprises the huge page file and a size.

7. The method according to claim 1, further comprising:
transmitting the huge page file table to the first container through the transmission protocol; and
mapping, by the first container, the huge page file table to a process space of the first container through memory file mapping.

8. The method according to claim 6, further comprising:
writing, by the first container, the data into at least one of the huge pages of the second container by modifying the huge page file table in the process space; and
writing the data into the disk through the at least one of the huge pages.

9. The method according to claim 1, further comprising:
removing the second container from the first pod in response to a threshold load reduction in the first pod.

10. A device, comprising:
a processor; and
a memory, the memory being coupled to the processor and storing instructions, wherein the instructions, when executed by the processor, cause the device to perform actions, comprising:
receiving data via a first container in a first pod of the device;
transmitting the data from the first container to a second container in the first pod using a transmission protocol, wherein the second container is used for assistance in implementing functions of the first pod and comprises huge pages; and
writing the data to a disk via the second container.

11. The device according to claim 10, wherein the second container is in a second pod, and wherein the second pod is connected to the first pod using the transmission protocol and provides services for the first pod, and the actions further comprise:
deploying, in response to a load change in the first pod, one or more of the huge pages of the second pod to the second container; and
deploying the second container to the first pod.

12. The device according to claim 11, wherein deploying the one or more of the huge pages of the second pod to the second container comprises:
generating input/output (IO) worker threads by binding the one or more of the huge pages to a core in a central processing unit; and
deploying the IO worker threads to the second container.

13. The device according to claim 12, wherein the actions further comprise:
allocating the IO worker threads in accordance with a number of interfaces of the transmission protocol connected to the second pod, as a result of which each interface of the transmission protocol has a same number of IO worker threads.

14. The device according to claim 12, wherein the IO worker threads are non-blocking IO threads, and the IO worker threads are polled to confirm availability for deployment of the IO worker threads to the second container.

15. The device according to claim 10, wherein writing the data to the disk via the second container comprises:
generating, by the second container, a huge page file table based on one or more of the huge pages deployed in the second container, wherein the huge page file table comprises the huge page file and a size.

16. The device according to claim 10, wherein the actions further comprise:
transmitting the huge page file table to the first container using the transmission protocol; and
mapping, by the first container, the huge page file table to a process space of the first container using memory file mapping.

17. The device according to claim 16, wherein the actions further comprise:
writing, by the first container, the data into one or more of the huge pages of the second container by modifying the huge page file table in the process space; and
writing the data into the disk using the one or more of the huge pages.

18. The device according to claim 10, wherein the actions further comprise:
removing the second container from the first pod in response to a load reduction in the first pod.

19. A computer program product, the computer program product being stored on a non-transitory computer-readable storage medium and comprising computer-executable instructions, wherein the computer-executable instructions, when executed, cause a computer to perform operations, comprising:
receiving data at a first container in a first pod;
transmitting the data from the first container to a second container in the first pod in accordance with a transmission protocol, wherein the second container is used for assistance in implementing functions of the first pod and comprises huge pages; and
writing the data to a disk through the second container.

20. The computer program product according to claim 19, wherein the second container is in a second pod, and wherein the second pod is connected to the first pod in accordance with the transmission protocol and provides services on behalf of the first pod, and the operations further comprise:
deploying, in response to a load change in the first pod, a huge page of the huge pages of the second pod to the second container; and
deploying the second container to the first pod.
